(19) United States
(12) Patent Application Publication
(10) Pub. No.: US 2003/0160026 A1
(43) Pub. Date: Aug. 28, 2003

(54) Etching pastes for inorganic surfaces

(76) Inventors: Sylke Klein, Rossdorf (DE); Lilia Heider, Riedstadt (DE); Claudia Zielinski, Darmstadt (DE); Armin Kuebelbeck, Bensheim (DE); Werner Stockum, Reinheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/258,747

(22) PCT Filed: Mar. 23, 2001
(86) PCT No.: PCT/EP01/03317

(30) Foreign Application Priority Data
Apr. 28, 2000 (DE) 100 20 817.7
Jan. 16, 2001 (DE) 101 01 926.2

(51) Int. Cl. C03C 25/68

(52) U.S. Cl. 216/83; 252/79.1

(57) ABSTRACT

The invention relates to novel etching media in the form of printable, homogenous, particle-free etching pastes with non-Newtonian flow properties for the etching of inorganic surfaces, in particular, of glasses, preferably on silicon oxide and silicon nitride based glass and other silicon oxide and silicon nitride based systems and layers thereof. The invention further relates to the use of said etching media.

The present invention relates to novel etching media in the form of printable, homogeneous, particle-free etching pastes having non-Newtonian flow behaviour for etching inorganic, glass-like amorphous or crystalline surfaces, in particular of glasses or ceramics, preferably on SiO₂- or silicon nitride-based systems, and to the use of these etching media.

The term ‘inorganic surfaces’ is taken to mean oxidic and nitride-containing compounds of silicon, in particular silicon oxide and silicon nitride surfaces.

Definition of Glass:

The term ‘glass’ is per se taken to mean a uniform material, for example quartz glass, window glass or borosilicate glass, and also thin layers of these materials produced on other substrates (for example ceramics, metal sheeting or silicon wafers) by various processes known to the person skilled in the art (CVD, PVD, spin-on, thermal oxidation, inter alia).

The term ‘glasses’ below is taken to mean silicon oxide- and silicon nitride-containing materials which exist in the solid amorphous state without the glass components crystallizing out and have a high degree of disorder in the microstructure owing to the lack of a long-range order.

Besides pure SiO₂ glass (quartz glass), all glasses are included (for example doped glasses, such as borosilicate, phosphosilicate and borophospho-silicate glasses, coloured, milk and crystal glasses, optical glasses) which comprise SiO₂ and other components, in particular elements such as, for example, calcium, sodium, aluminium, lead, lithium, magnesium, barium, potassium, boron, beryllium, phosphorus, gallium, arsenic, antimony, lanthenum, zinc, thorium, copper, chromium, manganese, iron, cobalt, nickel, molybdenum, vanadium, titanium, gold, platinum, palladium, silver, cerium, caesium, niobium, tantalum, zirconium, neodymium and praseodymium, which occur in the glasses or function as doping elements in the glasses in the form of oxides, carbonates, nitrates, phosphates, sulfates and/or halides. Doped glasses are, for example, borosilicate, phosphosilicate and borophosphosilicate glasses, coloured, milk and crystal glasses and optical glasses.

The silicon nitride may likewise comprise other elements, such as boron, aluminium, gallium, indium, phosphorus, arsenic or antimony.

Definition of Silicon Oxide- and Silicon Nitride-Based Systems:

The term ‘silicon oxide-based systems’ is applied below to all crystalline systems which do not fall under the definition given above for amorphous SiO₂ glasses and are based on silicon dioxide; these can be, in particular, the salts and esters of orthosilicic acid and condensation products thereof—generally referred to as silicates by the person skilled in the art—and quartz and glass-ceramics.

This definition also covers other silicon oxide- and silicon nitride-based systems, in particular the salts and esters of orthosilicic acid and condensation products thereof. Besides pure SiO₂ (quartz, tridymite and cristobalite), the definition covers all SiO₂-based systems that are built up from SiO₂ or from ‘discrete’ and/or linked [SiO₄]tetrahedra, such as, for example, nesosilicates, sorosilicates, cyclosilicates, inosilicates, phyllo-silicates and tectosilicates, and other components, in particular elements/components such as, for example, calcium, sodium, aluminium, lithium, magnesium, barium, potassium, beryllium, scandium, manganese, iron, titanium, zirconium, zinc, cerium, yttrium, oxygen, hydroxyl groups and halides.

The term ‘silicon nitride-based systems’ is applied below to all crystalline and partially crystalline (usually referred to as microcrystalline) systems which do not fall under the definition given above for amorphous silicon nitride glasses/layers. These include Si₃N₄ in its α-Si₃N₄ and β-Si₃N₄ modifications and all crystalline and partially crystalline SiNₓ and SiNₓ:H layers. The crystalline silicon nitride may be doped by other elements, such as boron, aluminium, gallium, indium, phosphorus, arsenic and antimony.

1. Etching of Structures on Glass

The use of etchants, i.e. chemically aggressive compounds, causes dissolution of the material subjected to the attack by the etchant. It is not only the first layer of the attack surface but also—seen from the attack surface—deeper layers that are attacked and removed.

2. Etching of Structures on Silicon Oxide- and Silicon Nitride-Based Glasses and Other Silicon Oxide- and Silicon Nitride-based Systems

According to the current state of the art, any desired structures can be etched selectively in silicon oxide- and silicon nitride-based glasses and other silicon oxide- and silicon nitride-based systems or their surfaces or their layers of variable thickness, directly by laser-supported etching methods or, after masking, by wet-chemical methods [1,2] or by dry-etching methods [3].

In the laser-supported etching methods, the laser beam scans the entire etch pattern point for point on the glass, which, in addition to a high degree of precision, also requires considerable adjustment effort and is very time-consuming.

The wet-chemical and dry etching methods include material-intensive, time-consuming and expensive process steps:

A. masking of the areas not to be etched, for example by:

photolithography: production of a negative or positive of the etch structure (depending on the resist), coating of the substrate surface (for example by spin coating with a suitable photoresist), drying of the photoresist, exposure of the coated substrate surface, development, rinsing, if desired drying

B. etching of the structures by:

dip methods (for example wet etching in wet-chemical banks): dipping of the substrates into the etch bath, etching process, repeated rinsing in H₂O cascade basins, drying

spin-on or spray methods: the etching solution is applied to a rotating substrate, the etching operation can take place without/with input of energy (for example IR or UV irradiation), and this is followed by rinsing and drying

dry-etching methods, such as, for example, plasma etching in expensive vacuum units or etching with reactive gases in flow reactors

[1] D. J. Monk, D. S. Soane, R. T. Howe, Thin Solid Films 232 (1993), 1

[2] J. Bühler, F.-P. Steiner, H. Baltes, J. Micromech. Microeng. 7 (1997), R1

[3] M. Kohler “Ätzfverfahren für die Mikrotechnik” [Etching Methods for Microtechnology], Wiley VCH 1998.

3. Full-Area Etching of Silicon Oxide- and Silicon Nitride-Based Glasses and Other Silicon Oxide- and Silicon Nitride-Based Systems

In order to etch silicon oxide- and silicon nitride-based glasses and other silicon oxide- and silicon nitride-based systems and their layers of variable thickness to a certain depth over the entire area, use is predominantly made of wet-etching methods. The silicon oxide- and silicon nitride-based glasses and other silicon oxide- and silicon nitride-based systems and their layers of variable thickness are dipped into etch baths, which usually contain toxic and highly corrosive hydrofluoric acid or another mineral acid as etching component.

The disadvantages of the etching methods described are due to the time-consuming, material-intensive, expensive process steps which are in some cases complex from a technologically or safety point of view or are carried out batchwise.

The object of the present invention is therefore to provide an etching medium which can be employed in a technologically simple etching method with high potential throughputs for inorganic surfaces, in particular for glass and other silicon oxide- or silicon nitride-based systems, and their layers of variable thickness, this simple etching method being significantly less expensive than conventional wet and dry etching methods in the liquid or gas phase.

The invention thus relates to printable, homogeneous, particle-free etching pastes which have an advantageous, non-Newtonian flow behaviour, and to the use thereof for etching inorganic surfaces, in particular surfaces of silicon oxide- and silicon nitride-based glasses and other silicon oxide- and silicon nitride-based systems and their layers of variable thickness.

The invention also relates to the use of these homogeneous, particle-free etching pastes which have non-Newtonian flow behaviour in—compared with the conventional wet and dry etching methods in the liquid or gas phase—less expensive, technologically simple printing/etching methods for glass and for other silicon dioxide- and silicon nitride-based systems which are suitable for high throughputs and can be carried out continuously.

The production, shaping and aftertreatment, such as, for example, grinding, polishing, lapping and heat treatment, of the SiO₂-based systems are—as in the case of the glasses—unimportant for the use described in accordance with the invention of printable, homogeneous, particle-free etching pastes having non-Newtonian flow behaviour.

The invention relates both to the etching of SiO₂- or silicon nitride-coated substrates as uniform, full, nonporous and porous solids (for example glass grains and powders, and flat, hollow, mirror or sintered glass), obtained, for example, from glass melts, and also to the etching of nonporous and porous glass layers of variable thickness which have been produced on other substrates (for example on ceramics, metal sheeting or silicon wafers) by various methods known to the person skilled in the art (for example CVD, PVD, spin-on of Si-containing precursors, thermal oxidation . . . ).

The etching pastes are applied in a single process step to the substrate surface to be etched. The surface to be etched can be a surface or part-surface on a homogeneous, solid, porous or nonporous element made from silicon oxide- or silicon nitride-based glass or other silicon oxide- or silicon nitride-based systems (for example the surface of a silicon oxide glass sheet) and/or a surface or part-surface of a porous or nonporous layer of glass or other silicon oxide- or silicon-nitride based systems on a support material.

A method with a high degree of automation and high throughput which is suitable for transfer of the etching paste to the substrate surface to be etched uses printing technology. In particular, screen printing, silk-screen printing, pad printing, stamp printing and ink-jet printing methods are printing methods which are known to the person skilled in the art. Manual application is likewise possible.

Depending on the design of the screen, silk screen, klischee or stamp or the cartridge addressing, it is possible to apply the printable, homogeneous, particle-free etching pastes having non-Newtonian flow behaviour which are described in accordance with the invention over the entire area or selectively in accordance with the etch structure mask only to the points at which etching is desired. All masking and lithography steps as described under A) are unnecessary. The etching operation can take place with or without input of energy, for example in the form of heat radiation (using IR emitters). After etching is complete, the printable, homogeneous, particle-free etching pastes having non-Newtonian flow behaviour are rinsed off the etched surface using a suitable solvent or burnt out.

By variation of the following parameters, the etch depth in silicon oxide- and silicon nitride-based glasses or other silicon oxide- and silicon nitride-based systems and their layers of variable thickness, and in the case of selective structure etching, in addition the edge sharpness of the etch structures can be adjusted;

concentration and composition of the etching components

concentration and composition of the solvents employed

concentration and composition of the thickener systems

concentration and composition of any acids added

concentration and composition of any additives added, such as antifoams, thixotropic agents, flow-control agents, deaeration agents and adhesion promoters

viscosity of the printable, homogeneous, particle-free etching pastes having non-Newtonian flow behaviour which are described in accordance with the invention

etching duration with or without input of energy into the inorganic surfaces printed with the respective printing paste and their layers, and

input of energy into the system printed with the etching paste.

The etching duration can be between a few seconds and several minutes, depending on the application, desired etching depth and/or edge sharpness of the etch structures. In general, an etching duration of between 1 and 15 minutes is set.

The printable, homogeneous, particle-free etching pastes having non-Newtonian flow behaviour which are described in accordance with the invention are—compared with liquid, dissolved or gaseous etchants, such as inorganic mineral acids from the group consisting of hydrofluoric acid, fluorides, HF gas and SF₆—advantageously significantly simpler and safer to handle and are significantly more economical with respect to the amount of etchant.

The printable, homogeneous, particle-free etching pastes having non-Newtonian flow behaviour according to the invention have the following composition:

a. an etching component for glass or for other SiO₂-based systems and layers thereof

b. solvent

c. thickener

d. if desired, organic and/or inorganic acid(s)

e. if desired, additives, such as antifoams, thixotropic agents, flow-control agents, deaeration agents and adhesion promoters.

The etching action of the printable, homogeneous, particle-free etching pastes having non-Newtonian flow behaviour which are described in accordance with the invention on surfaces of silicon oxide- and silicon nitride-based glasses and other silicon oxide- and silicon nitride-based systems is based on the use of solutions of fluoride-containing components with or without addition of acid, in particular solutions of fluorides, bifluorides, tetrafluoroborates, such as, for example, ammonium, alkali metal and antimony fluorides, ammonium, alkali metal and calcium bifluorides, alkylated ammonium and potassium tetrafluoroborates, and mixtures thereof. These etching components are effective in the etching pastes even at temperatures in the range from 15 to 50° C., in particular at room temperature, and/or are activated by input of energy, for example by thermal radiation by IR emitters (up to about 300° C.), UV or laser radiation.

The proportion of the etching components employed is in a concentration range of from 2 to 20% by weight, preferably in the range from 5 to 15% by weight, based on the total weight of the etching paste.

The solvent may form the principal constituent of the etching paste. The proportion can be in the range from 10 to 90% by weight, preferably in the range from 15 to 85% by weight, based on the total weight of the etching paste.

Suitable solvents may be inorganic and/or organic solvents, or mixtures thereof. Suitable solvents, which can be employed in pure form or in corresponding mixtures, may be, depending on the application:

water

simple or polyhydric alcohols, such as, for example, diethylene glycol, dipropylene glycol, 1,2-propanediol, 1,4-butanediol, 1,3-butanediol, glycerol, 1,5-pentanediol, 2-ethyl-1-hexanol, or mixtures thereof,

ketones, such as, for example, acetophenone, methyl-2-hexanone, 2-octanone, 4-hydroxy-4-methyl-2-pentanone or 1-methyl-2-pyrrolidone

ethers, such as ethylene glycol monobutyl ether, triethylene glycol monomethyl ether, diethylene glycol monobutyl ether or dipropylene glycol monomethyl ether

carboxylic acid esters, such as [2,2-butoxy(ethoxy)]ethyl acetate

esters of carbonic acid, such as propylene carbonate

inorganic mineral acids, such as hydrochloric acid, phosphoric acid, sulfuric acid or nitric acid, or organic acids which have an alkyl radical chain length of n=1-10, or mixtures thereof. The alkyl radical may be either straight-chain or branched. In particular, organic carboxylic, hydroxy-carboxylic and dicarboxylic acids, such as formic acid, acetic acid, lactic acid, oxalic acid or the like, are suitable.

These solvents or mixtures thereof are, inter alia, also suitable for removing the etching medium again after etching is complete and, if desired, cleaning the etched surface.

The viscosity of the printable, homogeneous, particle-free etching pastes having non-Newtonian flow behaviour which are described in accordance with the invention is achieved by network-forming thickeners which swell in the liquid phase and can be varied depending on the desired area of application. The printable, homogeneous, particle-free etching pastes having non-Newtonian flow behaviour which are described in accordance with the invention include all etching pastes whose viscosity is not independent of the shear rate, in particular etching pastes having a shear-thinning action. The network produced by thickeners collapses under shear stress. The restoration of the network can take place without time delay (non-Newtonian etching pastes having a plastic or pseudoplastic flow behaviour) or with a time delay (etching pastes having a thixotropic flow behaviour).

The printable, homogeneous, particle-free etching pastes having non-Newtonian flow behaviour are completely homogeneous with addition of thickener. Particulate thickeners, such as, for example, particulate silicone or acrylic resins, are not used.

Possible thickeners are polymers based on the following monomer units:

glucose units

β-glucosidically linked, i.e. cellulose and/or cellulose derivatives, such as cellulose ethers, in particular ethyl- (for example Aqualon® EC), hydroxylpropyl- (for example Klucel®) and hydroxyethylcellulose (for example Natrosol®), and salts of the glycol acid ether of cellulose, in particular sodium carboxymethylhydroxyethylcellulose (for example Na-CMHEC)

α-glucosidically linked, i.e. starch and/or starch derivatives, such as oxidized starch, in particular sodium carboxymethylstarch (vivastar® P0100 or vivastar® P5000), and starch ethers, in particular anionic heteropolysaccharides (Deuteron® VT819 or Deuteron® XG)

functionalized methacrylate units, in particular cationic methacrylatelmethacrylamide, such as Borchigel® A PK

functionalized vinyl units, i.e.

polyvinyl alcohols of various degree of hydrolysis, in particular Mowiol® 47-88 (partially hydrolysed, i.e. vinyl acetate and vinyl alcohol units) or Mowiol® 56-98 (fully hydrolysed)

polyvinylpyrolidones (PVP), in particular PVP K-90 or PVP K-120

The thickeners can be employed individually or in combinations with other thickeners.

The proportion of the thickeners that is necessary for specific setting of the viscosity range and basically for the formation of a printable paste is in the range from 0.5 to 25% by weight, preferably from 3 to 20% by weight, based on the total weight of the etching paste.

As already described, the etching pastes according to the invention are also completely homogeneous with addition of thickener. They do not comprise any particulate thickeners, such as, for example, particulate silicone or acrylic resins.

Organic and inorganic acids whose pKₐ value is between 0 and 5 may have been added to the printable, homogeneous, particle-free etching pastes having non-Newtonian flow behaviour which are described in accordance with the invention. Inorganic mineral acids, such as, for example, hydrochloric acid, phosphoric acid, sulfuric acid and nitric acid, and also organic acids which have an alkyl radical chain length of n=1-10 improve the etching action of the printable, homogeneous, particle-free etching pastes having non-Newtonian flow behaviour. The alkyl radical of the organic acids may be either straight-chain or branched, with organic carboxylic, hydroxycarboxylic and dicarboxylic acids, such as formic acid, acetic acid, lactic acid and oxalic acid, or others being particularly suitable. The proportion of the acid(s) can be in the range from 0 to 80% by weight, based on the total weight of the etching paste.

Additives having properties which are advantageous for the desired purpose are antifoams, such as, for example, the one available under the trade name TEGO® Foamex N,

thixotropic agents, such as BYK® 410, Borchigel® Thixo2,

flow-control agents, such as TEGO® Glide ZG 400,

deaeration agents, such as TEGO® Airex 985, and

adhesion promoters, such as Bayowet® FT 929.

These may have a positive effect on the printability of the printing paste. The proportion of the additives is in the range from 0 to 5% by weight, based on the total weight of the etching paste.

Areas of application for the etching pastes according to the invention are found, for example, in

the solar cell industry (photovoltaic components, such as solar cells and photodiodes)

the semiconductor industry

the glass industry

high-performance electronics

The novel printable, homogeneous, particle-free etching pastes having non-Newtonian behaviour according to the invention can be employed, in particular, in all cases where full-area and/or structured etching of surfaces of silicon oxide- and silicon nitride-based glasses and other silicon oxide- and silicon nitride-based systems and their layers is desired.

Thus, entire surfaces, but also individual structures selectively can be etched down to the desired depth into uniform, solid, nonporous and porous glasses and other uniform, solid, nonporous and porous silicon oxide- and silicon nitride-based systems, i.e. the etching operation can cover all ranges between microstructural roughening (still transparent glasses with a light-scattering effect) via frosting/matting effects to etching of deep etch structures (for example markings, ornaments/patterns). Areas of application are, for example:

the production of viewing windows for valves and measuring equipment of all types

the production of glass supports for outdoor applications (for example for solar cells and heat collectors)

etched glass surfaces in the medical and sanitary sector, and for decorative purposes, including artistic and architectural applications

etched glass containers for cosmetic articles, foods and drinks

specific partial etching of glasses and other silicon oxide-based systems for marking and labelling purposes, for example for marking/labelling container glass and flat glass

specific partial etching of glasses and other silicon oxide-based systems for mineralogical, geological and microstructural studies

In particular, screen printing, silk-screen printing, pad printing, stamp printing and ink-jet printing methods are suitable techniques for applying the etching pastes as desired. In general, besides the said printing methods, manual application (for example brush) is also possible.

Besides industrial application, the etching pastes are also suitable for DIY and hobby needs.

The printable, homogeneous, particle-free etching pastes having non-Newtonian flow behaviour which are described in accordance with the invention can be employed in all cases where layers of glasses and other silicon oxide-based and silicon nitride-based systems of variable thickness are to be etched over the entire area and/or in a structured manner. Areas of application are, for example:

all etching steps on layers of silicon oxide- and silicon nitride-based glasses and other silicon oxide- and silicon nitride-based systems which result in the production of photovoltaic components, such as solar cells, photodiodes and the like, in particular

a) the removal of silicon oxide/doped silicon oxide (for example phosphorus glass after n-doping of the solar cell) and silicon nitride layers

b) the selective opening of passivation layers of silicon oxide and silicon nitride for the generation of two-stage selective emitters (after opening, re-doping in order to produce n⁺⁺ layers) and/or local p⁺ back surface fields (BSFs)

c) edge etching of silicon oxide- and/or silicon nitride-coated solar-cell panels

all etching steps on layers of silicon oxide- and silicon nitride-based glasses and other silicon oxide- and silicon nitride-based systems which result in the production of semiconductor components and circuits and which require the opening of passivation layers of silicon oxide and silicon nitride

all etching steps on layers of silicon oxide- and silicon nitride-based glasses and other silicon oxide- and silicon nitride-based systems which result in the production of components in high-performance electronics

In particular, screen printing, silk-screen printing, pad printing, stamp printing and ink-jet printing methods are suitable techniques for application of the etching pastes as desired. In general, besides the said printing methods, manual application is also possible.

Besides industrial application, the etching pastes are also suitable for DIY and hobby needs.

### EXAMPLES

For better understanding and for illustration, examples are given below which are within the scope of protection of the present invention, but are not suitable for restricting the invention to these examples.

### Example 1

| | |
|---|---|
| 21 g | of ethylene glycol monobutyl ether |
| 39 g | of 35% NH₄HF₂ solution |
| 30 g | of formic acid (98-100%) |
| 10 g | of PVP K-120 |

Ethylene glycol monobutyl ether and formic acid are introduced into a PE beaker. An aqueous 35% NH₄HF₂ solution is then added. PVP K-120 is then added successively with stirring (at least 400 rpm). During the addition and for about 30 minutes thereafter, vigorous stirring must be continued. The transfer into containers takes place after a short standing time. This standing time is necessary so that the bubbles formed in the etching paste are able to dissolve.

This mixture gives an etching paste with which silicon oxide- and silicon nitride-based glasses and other silicon oxide- and silicon nitride-based systems and their layers can be etched specifically down to the desired depth over the entire area or in structures with and/or without input of energy.

The etching rate, determined by photospectrometry, on a thermally generated silicon oxide layer is 120 nm/min in the case of etching over the entire area. The etching rate, determined by photospectrometry, on a silicon nitride layer generated by means of PE-CVD (refractive index n=1.98) is 70 nm/min in the case of etching over the entire area.

The etching paste obtained has a long shelf life, is easy to handle and is printable. It can be removed from the printed material or from the paste carrier (screen, knife, silk screen, stamp, klischee, cartridge, etc.), for example, using water, or burnt out in an oven.

### Example 2

| | |
|---|---|
| 22 g | of triethylene glycol monomethyl ether |
| 43 g | of 35% NH₄HF₂ solution |
| 20 g | of demineralized water |
| 12 g | of PVP K-120 |

Triethylene glycol monomethyl ether is initially introduced, and all the liquid components are added with stirring as in Example 1. Finally, the thickener PVP K-120 is introduced successively with stirring (at least 400 rpm). During the addition and for about 30 minutes thereafter, vigorous stirring must be continued. The transfer into containers takes place after a short standing time. This standing time is necessary in order that the bubbles formed in the etching paste are able to dissolve.

This mixture gives an etching paste with which silicon oxide- and silicon nitride-based glasses and other SiO₂- and silicon nitride-based systems and their layers can be etched specifically down to the desired depth over the entire area or in structures with and/or without input of energy.

The etching rate, determined by photospectrometry, on a thermally generated silicon oxide layer is 106 nm/min in the case of etching over the entire area.

The etching paste obtained has a long shelf life, is easy to handle and is printable. It can be removed from the printed material or from the paste carrier (screen, knife, silk screen, stamp, klischee, cartridge, etc.), for example, using water or burnt out in an oven.

### Example 3

| | |
|---|---|
| 12 g | of solid NH₄HF₂ |
| 142 g | of lactic acid |
| 10 g | of ethylcellulose |
| 36 g | of ethylene glycol monobutyl ether |

The ethylcellulose is stirred successively into the initially introduced ethylene glycol monobutyl ether at 40° C. in a water bath. The solid NH₄HF₂ is dissolved in the lactic acid, likewise with stirring, and subsequently added to the ethylcellulose stock paste. The two together are then stirred at 600 rpm for 2 hours.

This mixture gives an etching paste with which silicon oxide- and silicon nitride-based glasses and other silicon oxide- and silicon nitride-based systems and their layers can be etched specifically down to the desired depth over the entire area or in structures with and/or without input of energy.

The etching rate, determined by photospectrometry, on a thermally generated silicon oxide layer is 23 nm/min in the case of etching over the entire area.

The etching paste obtained has a long shelf life, is easy to handle and is printable. It can be removed from the printed material or from the paste carrier (screen, knife, silk screen, stamp, klischee, cartridge, etc.), for example, using acetone or butyl acetate or burnt out in an oven.

### Example 4

| | |
|---|---|
| 15 g | of ethylene glycol monobutyl ether |
| 15 g | of triethylene glycol monomethyl ether |
| 29 g | of propylene carbonate |
| 72 g | of formic acid |
| 46 g | of 35% NH₄HF₂ solution |
| 24 g | of PVP K-90 |

The solvent mixture and the formic acid are introduced into a PE beaker. An aqueous 35% NH₄HF₂ solution is then added. PVP K-120 is then added successively with stirring (at least 400 rpm). During the addition and for about 30 minutes thereafter, vigourous stirring must be continued. The transfer into containers takes place after a short standing time. This standing time is necessary so that the bubbles formed in the etching paste are able to dissolve.

This mixture gives an etching paste with which silicon oxide- and silicon nitride-based glasses and other silicon oxide- and silicon nitride-based systems and their layers can be etched specifically down to the desired depth over the entire area or in structures with and/or without input of energy.

The etching rate, determined by photospectrometry, on a thermally generated silicon oxide layer is 67 nm/min in the case of selective etching of structures with a width of about 80 μm. The etching rate, determined by photo-spectrometry, on a silicon nitride layer generated by means of PE-CVD is 35 nm/min in the case of selective etching of structures with a width of about 100 μm and at an etching temperature of 40° C.

The etching paste obtained has a long shelf life, is easy to handle and is printable. It can be removed from the printed material or from the paste carrier (screen, knife, silk screen, stamp, klischee, cartridge, etc.), for example, using water, or burnt out in an oven.

1. Printable, homogenous, particle-free etching medium having non-Newtonian flow behaviour for etching inorganic, glass-like or crystalline surfaces.

2. Printable etching medium according to claim 1 for surfaces of glasses selected from the group consisting of the glasses based on silicon oxide and the glasses based on silicon nitride.

3. Printable etching medium according to claims 1 and 2, for surfaces of glasses comprising elements selected from the group consisting of calcium, sodium, aluminium, lead, lithium, magnesium, barium, potassium, boron, beryllium, phosphorus, gallium, arsenic, antimony, lanthanum, scandium, zinc, thorium, copper, chromium, manganese, iron, cobalt, nickel, molybdenum, vanadium, titanium, gold, platinum, palladium, silver, cerium, caesium, niobium, tantalum, zirconium, yttrium, neodymium and praseodymium.

4. Printable etching medium according to claims 1 to 3, characterized in that it is an etching paste having non-Newtonian flow behaviour.

5. Printable etching medium according to claims 1 to 4, characterized in that it is a homogeneous, particle-free etching paste which comprises
a) at least one etching component for inorganic surfaces,
b) solvent
c) thickener and
d) if desired, organic and/or inorganic acid, and, if desired,
e) additives, such as antifoams, thixotropic agents, flow-control agents, deaeration agents and adhesion promoters, is effective even at temperatures of from 15 to 50° C. or is activated, if necessary, by input of energy.

6. Etching medium according to claim 5, characterized in that it comprises, as etching component, at least one compound selected from the group consisting of the fluorides, bifluorides and tetrafluoroborates and, if desired, at least one inorganic and/or organic acid, where the etching component(s) is (are) present in a concentration of from 2 to 20% by weight, preferably from 5 to 15% by weight, based on the total amount.

7. Etching medium according to claims 5 and 6, characterized in that it comprises, as etching component, at least one fluorine compound selected from the group consisting of the ammonium, alkali metal and antimony fluorides, ammonium, alkali metal and calcium bifluorides, and alkylated ammonium and potassium tetrafluoroborates and if desired, at least one inorganic mineral acid selected from the group consisting of hydrochloric acid, phosphoric acid, sulfuric acid and nitric acid and/or, if desired, at least one organic acid, which may contain a straight-chain or branched alkyl radical having 1-10 carbon atoms, selected from the group consisting of alkylcarboxylic acids, hydroxycarboxylic acids and dicarboxylic acids.

8. Etching medium according to claim 5, characterized in that it comprises an organic acid selected from the group consisting of formic acid, acetic acid, lactic acid and oxalic acid.

9. Etching medium according to claims 5 to 8, characterized in that the proportion of the organic and/or inorganic acids is in a concentration range from 0 to 80% by weight, based on the total amount of the medium, the added acids each having a pKₐ value of between 0 and 5.

10. Etching medium according to claim 5, characterized in that it comprises, as solvent, water, monohydric or polyhydric alcohols, such as glycerol, 1,2-propanediol, 1,4-butanediol, 1,3-butanediol, 1,5-pentanediol, 2-ethyl-1-hexenol, ethylene glycol, diethylene glycol and dipropylene glycol, and ethers thereof, such as ethylene glycol monobutyl ether, triethylene glycol monomethyl ether, diethylene glycol monobutyl ether and dipropylene glycol monomethyl ether, and esters, such as [2,2-butoxy(ethoxy)]ethyl acetate, esters of carbonic acid, such as propylene carbonate, ketones, such as acetophenone, methyl-2-hexanone, 2-octanone, 4-hydroxy-4-methyl-2-pentanone and 1-methyl-2-pyrrolidone, as such or as a mixture, in an amount of from 10 to 90% by weight, preferably in an amount of from 15 to 85% by weight, based on the total amount of the medium.

11. Etching medium according to claim 5, characterized in that it comprises from 0.5 to 25% by weight, preferably from 3 to 20% by weight, based on the total amount of the etching medium, of, as thickener, cellulose/cellulose derivatives, starch/starch derivatives and/or polymers based on acrylate or functionalized vinyl units.

12. Etching medium according to claim 5, characterized in that it comprises from 0 to 5% by weight, based on the total amount, of additives selected from the group consisting of antifoams, thixotropic agents, flow-control agents, deaeration agents and adhesion promoters.

13. Use of an etching medium according to claims 1-12 in an etching method in which it is applied to the surface to be etched and removed again after an exposure time of 1-15 minutes.

14. Use of an etching medium according to claims 1 to 12 in the photo-voltaics, semiconductor technology, high-performance electronics, mineralogy or glass industries and for the production of photodiodes, of viewing windows for valves or measuring equipment, of glass supports for outdoor applications, for the production of etched glass surfaces in the medical, decorative and sanitary sectors, for the production of etched glass containers for cosmetic articles, foods and drinks, for the production of markings or labels on containers and in the production of flat glass.

15. Use of an etching medium according to claims 1 to 12 in screen printing, silk-screen printing, pad printing, stamp printing, ink-jet printing and manual printing methods.

16. Use of an etching medium according to claims 1 to 12 for the production of glass supports for solar cells or for thermal collectors.

17. Use of an etching medium according to claims 1 to 12 for etching SiO₂- or silicon nitride-containing glasses as uniform, full, nonporous or porous solids or of corresponding nonporous or porous glass layers of variable thickness which have been produced on other substrates.

18. Use of an etching medium according to claims 1-12 for etching uniform, solid, nonporous or porous glasses based on silicon oxide or silicon nitride systems and of variable-thickness layers of such systems.

19. Use of an etching medium according to claims 1 to 12 for the removal of silicon oxide/doped silicon oxide and silicon nitride layers, for the selective opening of passivation layers of silicon oxide and silicon nitride for the generation of two-stage selective emitters and/or local p⁺ back surface fields and for the edge etching of silicon oxide- and silicon nitride-coated solar cells.

20. Use of an etching medium according to claims 1 to 12 for opening passivation layers of silicon oxide and silicon nitride in the process for the production of semiconductor components and their circuits.

21. Use of an etching medium according to claims 1 to 12 for opening passivation layers of silicon oxide and silicon nitride in the process for the production of components for high-performance electronics.

22. Use of an etching medium according to claims 1 to 12 for mineralogical, geological and microstructural studies.

23. Method for etching inorganic, glass-like, crystalline surfaces, characterized in that an etching medium according to claims 1-12 is applied over the entire area or specifically in accordance with the etch structure mask only to the points at which etching is desired, and, after etching is complete, is rinsed off with a solvent or solvent mixture of burnt off in an oven.

24. Method according to claim 23, characterized in that the etching medium is rinsed off with water after the etching is complete.
